(19) United States
(12) Patent Application Publication
(10) Pub. No.: US 2006/0172044 A1
(43) Pub. Date: Aug. 3, 2006

(54) Method for storing and shipping fruit and container for use with said method

(76) Inventors: Raul Fernandez, Weston, FL (US); Andrew M. Hamilton, Bentonville, AR (US); Franklin A. Sanabria Vargas, San Jose (CR); Francisco J. Rodriguez Murillo, Alaguela (CR)

Correspondence Address: FROST BROWN TODD, LLC, 2200 PNC CENTER, 201 E. FIFTH STREET, CINCINNATI, OH, 45202, US

(21) Appl. No.: 11/289,815

(22) Filed: Nov. 30, 2005

Related U.S. Application Data
(60) Provisional application No. 60/632,808, filed on Dec. 3, 2004.

(51) Int. Cl. A23B 7/148

(52) U.S. Cl. 426/106

(57) ABSTRACT

A method for storing and transporting fruit, particularly bananas, so as to provide an optimized atmosphere for ripening of the fruit, is disclosed. The method utilizes fruit placed within a flexible bag which is placed in a box comprising a container and a lid. In this method, the lid is removed from the box and the neck of the flexible bag is opened so that the fruit is open to the atmosphere. A flexible cover, which is at least partially gas-permeable, is placed over the opening of the container; and the lid is replaced on the box over the flexible cover.

### CROSS-REFERENCE TO RELATED APPLICATION

This application is related to and claims priority from U.S. Provisional Patent Application Ser. No. 60/632,808, Fernandez et al., filed Dec. 3, 2004.

### FIELD OF THE INVENTION

The invention refers to the field of storage, transportation, and preparation for sale of fruit—particularly, bananas.

### BACKGROUND OF THE INVENTION

From the moment various types of fruit are harvested, until the time they are purchased by end users, different storage and transportation modes are necessary.

Storage modes could be characterized by different temperatures, levels of humidity, and composition of the gas medium that serves as the environment for this fruit. If the storage modes are not adhered to, the fruit won't be delivered to the consumer in the required state (for example, in terms of fruit maturity), and will even spoil. In particular, during transportation and storage, banana clusters are frequently packaged into boxes while still green and non-ripened. These boxes are arranged in stacks and placed into large transportation containers. During loading and transportation, the temperature of 56° to 59° F. is maintained. The bananas can be stored at this temperature for a rather long time.

To start the process of banana ripening, temperature must be raised to between 60° and 62° F., and the composition of gas medium surrounding the bananas must be modified by adding ethylene. The combination of ethylene and increased temperature contributes to the start of the banana ripening process. However, subsequently, to prevent the bananas from ripening too quickly and/or spoiling, the ripening process should be conducted at a lower temperature, and in a specifically selected gas medium.

Such requirements necessitate development of special methods and means that change the gas medium composition and temperature of gas medium surrounding packaged bananas.

Inventions relating to transportation and storage of bananas, and optimizing their ripening during packaging, storage and transportation, are known. For example, U.S. Pat. No. 5,556,658, Raudalus et al., issued Sep. 17, 1996, describes a container system for transportation and storage of bananas. The system includes external tare, an internal container, and a flexible bag placed inside the container (with bananas inside the bag). The container has holes for ventilation, while the flexible bag has means for opening and closing. Such a design is said to ensure required ventilation and temperature mode for banana storage. The option to open the bag makes it possible to feed ethylene into the bag, to trigger the process of banana ripening.

U.S. Pat. No. 5,617,711, Rodriguez et al., issued Apr. 8, 1997, describes a method for manufacturing a container for banana transportation and storage. The essence of the method is that a flexible, internal container is inserted into the external tare prior to the placement of banana clusters. Then, banana clusters are placed into the internal container and arranged in layers, with interlayer gaps. Such a method for banana arrangement is said to ensure appropriate ventilation and uniform temperature throughout the entire inner space of the container.

U.S. Pat. No. 6,013,293, De Moor, issued Jan. 11, 2000, describes packaging that provides the required gas composition for storage of fruits, vegetables, and other biological materials. A membrane serves as an oxygen barrier and permeates oxygen at a lower rate than other gases, in particular, carbon dioxide and ethylene. The use of such a membrane during banana storage is said to ensure optimum conditions for banana ripening.

Different designs of containers for fruit storage, and boxes in which these containers are placed, are known. Some examples include U.S. Pat. No. 5,989,606, Sambrailo, issued Nov. 23, 1999; and U.S. Pat. No. 6,352,199, Gardner, issued Mar. 5, 2002.

However, these known methods and designs do not provide an optimal process of fruit storage and transportation, in particular, for bananas. The optimal process would combine the ease of packing and unpacking of fruit, with the optimum mode for fruit storage and ripening during transport and storage.

### SUMMARY OF THE INVENTION

The method outlined below offers facilitated packing and unpacking of fruit (in particular, bananas) and its storage at the required temperature and composition of gas medium, during the entire period of storage and transportation.

The method utilizes a modified container, with a lid; the pieces of fruit (especially, bananas clusters) are packaged into a flexible bag and placed inside the container. The method is applied during banana storage, when the ripening process has been triggered by an increase in temperature and feeding of ethylene. The banana container modification ensures the optimum gas medium around the stored bananas.

The method includes the following steps:

1. The container is opened by removing the lid. Then, the neck of the flexible bag is opened. The bag is then turned inside out, and its edges are pulled over the edges of the container walls.

2. After that, a flexible cover is pulled over the edges of the container walls and over the edges of the flexible bag. At least a portion of this cover is made from a gas-permeable membrane. The container lid is then replaced, to close the container.

Such repackaging is carried out quickly, easily, and as a result, it ensures banana storage in hermetically sealed packaging, with the required gas composition surrounding the bananas. Due to pulling the flexible cover, the bananas in the container are hermetically insulated from the external environment.

Further storage (after repackaging) is characterized, in contrast to known methods, by the ability to store bananas in less stringent temperature conditions, which is explained by hermetic sealing of the packaging and the presence of a gas-permeable membrane. The fruit could be stored at a decreased temperature, such as at room temperature.

The container design ensures reliable storage of bananas, which are insulated from the environment by the inner flexible bag. A gaseous medium required for optimal ripening is created around the bananas, inside the bag.

The container and its lid form the packaging box. Two opposite walls of the lid can be made in such a way that their heights gradually increase (from front to back of the lid), generally parallel to one another. One of the two remaining lid walls (which walls can have the same height) is preferably made so that when a box is in its assembled state, that lid wall projects outward.

Holes in the lid and container make the box easier to carry. When the box is in its assembled state, the holes are generally opposite one another.

The container and box lid could be made of cardboard.

The outward-projecting wall of the lid prevents boxes in stacks from shifting during transportation and storage.

The above-described lid could be used as a tray onto which retailers place fruit taken out of the box. For this purpose, a retailer would place the box upside-down, remove the container (and generally the inner flexible bag), and the fruit stored in the box would stay in the lid. The design of the lid walls makes it easier for buyers to see the fruit.

Information for buyers could be applied onto the inner side of the outward-projecting wall of the lid.

All patents and publications referenced in this application are incorporated by reference herein.

### BRIEF DESCRIPTION OF THE DRAWINGS

The present invention is illustrated by the following drawings:

FIG. 1 depicts a general view of the box;

FIG. 2 depicts a general view of the container; and

FIG. 3 depicts a general view of the lid.

FIG. 4 (a-e) illustrates the process of box repackaging.

FIG. 5 illustrates a fragment of a flexible cover, made, in part from a gas-permeable membrane.

FIG. 6 presents an example illustrating use of the lid as a tray, displaying fruit to buyers.

### DETAILED DESCRIPTION OF THE INVENTION

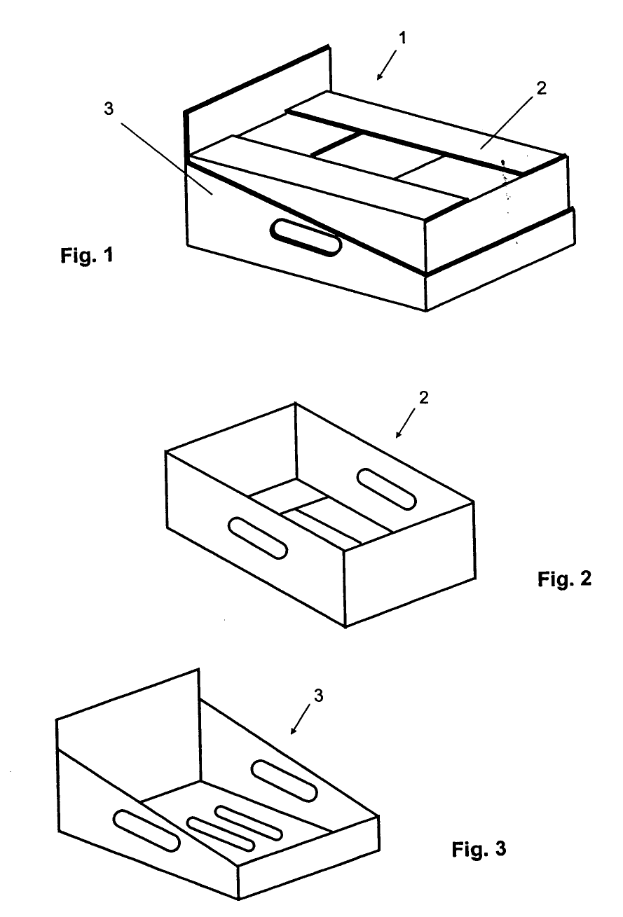

The box (1) (FIG. 1) for fruit packaging comprises the container (2) (into which fruit are placed) and the lid (3) to be put onto container 2. The container is shown in FIG. 2 and the lid is shown in FIG. 3.

Gathered bananas (10) are packed into a flexible bag (4). Such bags are known for use in the transportation of fruit. See, for example, U.S. Pat. No. 5,556,658, Raudalus et al., issued Sep. 17, 1996. The neck (7) of the flexible bag is not closed. Upon the temperature increase and introduction of gas (namely, ethylene), the banana-ripening process begins. After the banana-ripening process has begun, it is necessary to repack the box to create the optimal atmosphere for bananas during transportation and storage.

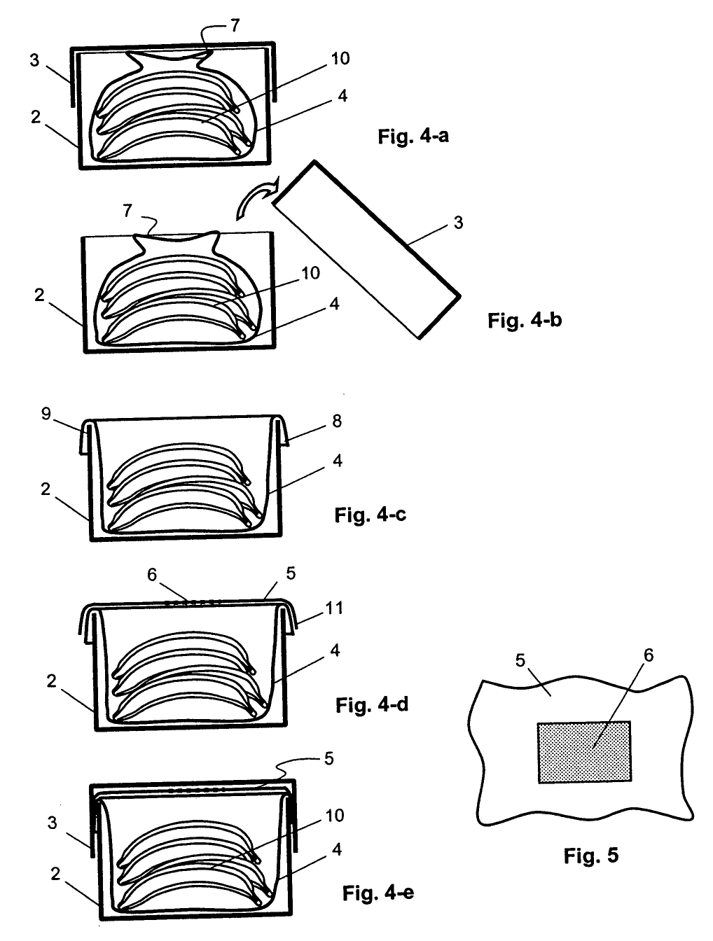

The repackaging method is implemented as shown in FIG. 4 a-e.

The box is put in such a way that the container is on the bottom. (FIG. 4-a). The lid is removed from the container (FIG. 4-b). Then, the neck of the flexible bag is opened, and the edges (8) of the flexible bag are pulled outward and over wall edges (9) of the container (FIG. 4-c). Then (FIG. 4-d), a flexible cover (5) at least a portion of which is made from a gas-permeable membrane (6) is pulled over wall edges of the container, and over the edges of the flexible bag. The flexible cover (5) can be fitted so that it fits tightly when pulled over the wall edges. Material described in U.S. Pat. No. 6,013,293, De Moor, issued Jan. 11, 2000, could be used for the gas-permeable membrane. At least a portion of the flexible cover is made from a gas permeable membrane. The membrane permeability can be designed to provide an optimized atmosphere in the container for shipping, storage and/or ripening. The remainder of the flexible cover (if any) is made from a conventional food grade non-gas permeable material.

FIG. 5 shows a fragment of the flexible cover made, in part, from a gas-permeable membrane (6).

The last step of the process consists of closing the container with the lid (FIG. 4-e).

The flexible bag containing bananas is placed in the container (FIG. 4-e). Edges of the flexible bag are pulled over wall edges of the container. Edges (11) of the flexible cover are pulled over wall edges of the container, and over the edges of the flexible bag.

A box (of the present invention) containing bananas could be opened for retail sale in the following manner.

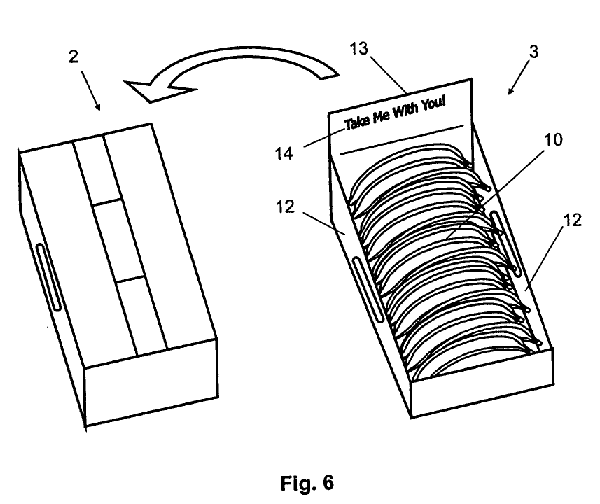

The box is placed in such a way that the lid is at the bottom and the container is on top. The container is taken off together with the flexible bag, and the fruit stays in the lid, on the flexible cover (FIG. 6).

Due to diagonal height variation of its walls (12), the lid can be a tray for fruit, which makes it easier for buyers to see the fruit.

One lid wall (13) is greater in height, and when the lid serves as a tray, special information (14) for buyers could be arranged on this wall.

What is claimed is:

1. A method for storing and shipping fruit utilizing a box comprising a container and a lid, said fruit being placed within a flexible bag having a neck which can be opened, said flexible bag being placed within said container which is covered by said lid; said method comprising the steps of:
(a) removing the lid and opening the neck of the flexible bag;
(b) placing a flexible cover over the edges of the container walls, said flexible cover being made, at least in part, from a gas-permeable membrane; and
(c) replacing the lid on the box over said flexible cover.

2. The method of claim 1 wherein the fruit is bananas.

3. The method of claim 2 wherein, in step (a), when the neck of the flexible bag is opened, said neck is pulled over the edges of the container walls.

4. The method of claim 3 wherein, in step (b), the flexible cover is pulled over both the edges of the container walls and the edges of the flexible bag.

5. The method of claim 2 wherein the gas-permeable portion of the flexible cover has permeability characteristics which provide an optimized atmosphere in the flexible bag for storage and ripening of the bananas.

6. The method according to claim 1 wherein the height of two opposite walls of the lid gradually increases from front to back of the lid, and parallel to each other.

7. The method according to claim 6 wherein the walls having increasing height are the side walls of the lid.

8. The method according to claim 7 wherein one of the walls of the lid, perpendicular to said side walls, is longer than its opposite wall, such that when the lid is assembled, said longer wall projects outward.

9. The method according to claim 8 wherein the inner side of said longer wall contains text and/or illustrations on it.

10. The method according to claim 7 wherein the box is placed on a surface such that the lid is at the bottom and the container is on top.

11. The method according to claim 10 wherein the container and the flexible bag are removed from the box, the lid acting as a display tray for the fruit.
